(19) United States
(12) Patent Application Publication
(10) Pub. No.: US 2009/0020521 A1
(43) Pub. Date: Jan. 22, 2009

(54) Heating Pad System For Orthopedic Braces And The Like

(76) Inventors: Thomas Blaszczykiewicz, Orchard Park, NY (US); Tamer Elsamahy, Cheektowaga, NY (US); Hari Venkataraman, Coimbatore (IN); Prasanna Chandrasekaran, Pondicherry (IN); Naresh Tondare, Udgir (IN)

Correspondence Address: HODGSON RUSS LLP;THE GUARANTY BUILDING, 140 PEARL STREET, SUITE 100, BUFFALO, NY, 14202-4040, US

(21) Appl. No.: 11/779,398

(22) Filed: Jul. 18, 2007

(51) Int. Cl. H05B 3/34

(52) U.S. Cl. 219/529

(57) ABSTRACT

A heating pad system comprises a pad formed of layers of flexible material, a heating element applied to or embedded within a layer of the pad and including conductive yarn, a temperature sensor associated with the pad to generate a temperature signal indicative of a temperature of the pad, and a battery-powered control module removably connected to the heating element and the temperature sensor. The control module is operable to supply current to the heating element to generate heat, wherein the current supplied to the heating element is regulated in response to the temperature signal from the temperature sensor to maintain the pad at a substantially constant temperature. The pad layers, heating element, and temperature sensor are machine-washable as a unit. The pad may be worn under an orthopedic or athletic brace.

### FIELD OF THE INVENTION

The present invention relates generally to heating pads for applying heat to muscles and joints to relieve pain and promote healing, and more particularly to heating pads usable with orthopedic braces and similar devices.

### BACKGROUND OF THE INVENTION

It is known to relieve pain and/or promote healing by localized application of heat to an effected area of the body, such as a joint or muscle group. Chemical or microwavable gel pads are available which provide heat to an application area, however the heat generation and transfer dissipates quickly.

Electric heating pads are available which provide constant heat for a more extended period of time. Typically, such electric heating pads plug into a standard AC outlet power source and include a removable cover that is machine-washable separately from the rest of the pad. Thus, the user must remain near a power outlet during treatment, and internal portions of the pad which may be exposed to perspiration or other contaminants are not machine-washable. Moreover, conventional electric heating pads are not intended to be used with an orthopedic or athletic brace that may be recommended for treatment, and thus the brace must be removed while heat is applied.

### SUMMARY OF THE INVENTION

It is therefore the object of the present invention to provide a heating pad system that maintains constant heat transfer, is readily transportable, and has a machine-washable pad.

It is another object of the present invention to provide a heating pad system that may be used while the user is wearing an orthopedic or athletic brace.

It is yet another object of the present invention to provide a heating element suitable for incorporation into a machine-washable heating pad.

In furtherance of these and other objects, a heating pad system is described that comprises a pad including a plurality of layers formed of flexible material; a heating element applied to or embedded within one of the layers, the heating element including conductive yarn; a temperature sensor associated with the pad, the temperature sensor generating a temperature signal indicative of a temperature of the pad; a control module removably connected to the heating element and the temperature sensor, the control module being operable to supply current to the heating element to generate heat, wherein the current supplied to the heating element is regulated in response to the temperature signal to maintain the pad at a substantially constant temperature; wherein the pad, heating element, and temperature sensor are machine-washable as a unit.

The invention also provides a machine-washable electric heating pad comprising an inner layer, an outer layer, and a middle layer between the inner and outer layers; and a heating element fixed to the middle layer, the heating element including conductive yarn.

As a further aspect of the present invention, a heating element for a machine-washable heating pad is described. The heating element comprises a plurality of parallel nonconductive warp threads; a nonconductive weft thread interlaced with the plurality of warp threads; and at least one conductive weft thread interlaced about one of the plurality of nonconductive warp threads.

### BRIEF DESCRIPTION OF THE DRAWINGS

The nature and mode of operation of the present invention will now be more fully described in the following detailed description of the invention taken with the accompanying drawing figures, in which:

FIG. 1 is a perspective view of a heating pad system formed in accordance with an embodiment of the present invention;

FIG. 2 is an exploded isometric view of a heating pad of the heating pad system shown in FIG. 1;

FIG. 3 is an enlarged plan view showing a woven tape heating element of the heating pad shown in FIG. 2; and

FIG. 4 is a schematic block diagram showing electrical circuitry of the heating pad system of the present invention.

### DETAILED DESCRIPTION OF THE INVENTION

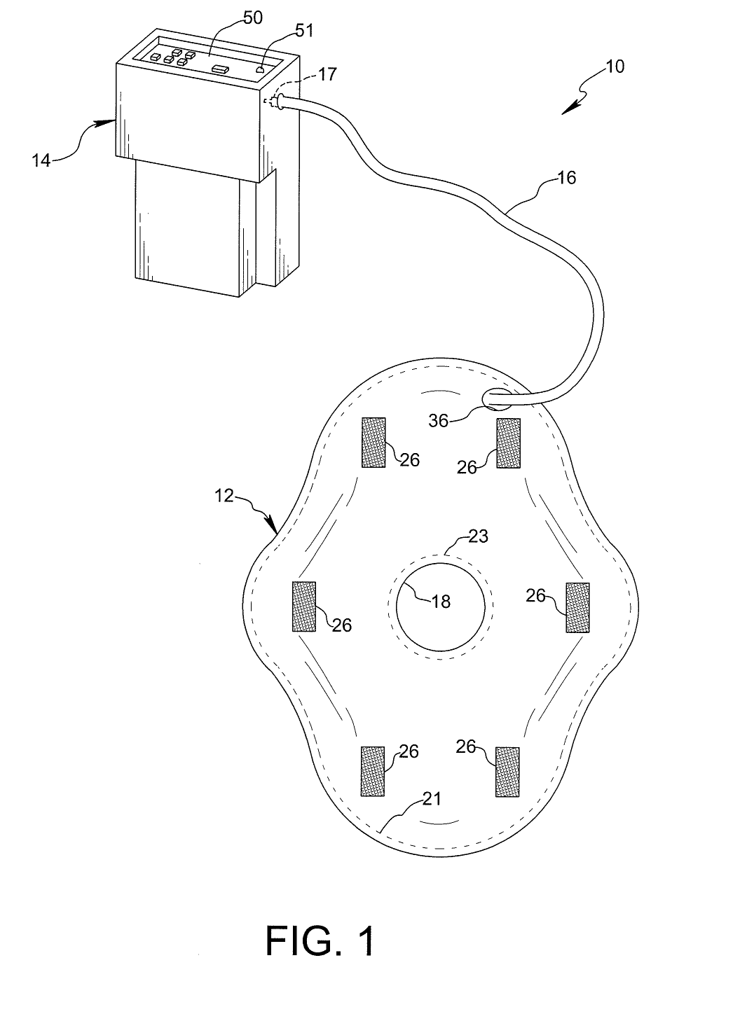

Reference is made initially to FIG. 1, wherein a heating pad system formed in accordance with an embodiment of the present invention is shown and designated generally by reference numeral 10. Heating pad system 10 is intended for use with an orthopedic brace (not shown) to apply heat to a joint or other area of a user's body to ease pain, promote healing, and improve flexibility. Heating pad system 10 generally comprises a heating pad 12 adapted to be worn against the skin and held in place by a surrounding orthopedic brace, for example a knee brace or an elbow brace, and a control module 14 connected to heating pad 12 by an electrical cord 16 for energizing heating pad 12. Electrical cord 16 may be provided with a plug connection element 17 at one or both ends thereof, with a mating receptacle being provided in control module 14 and/or at pad 12. The size and shape of heating pad 12 are open to variation depending upon the size of the user and the intended area of application on the user's body. Pad 12 depicted in FIG. 1 is shaped to be a knee pad, and includes a patella hole 18.

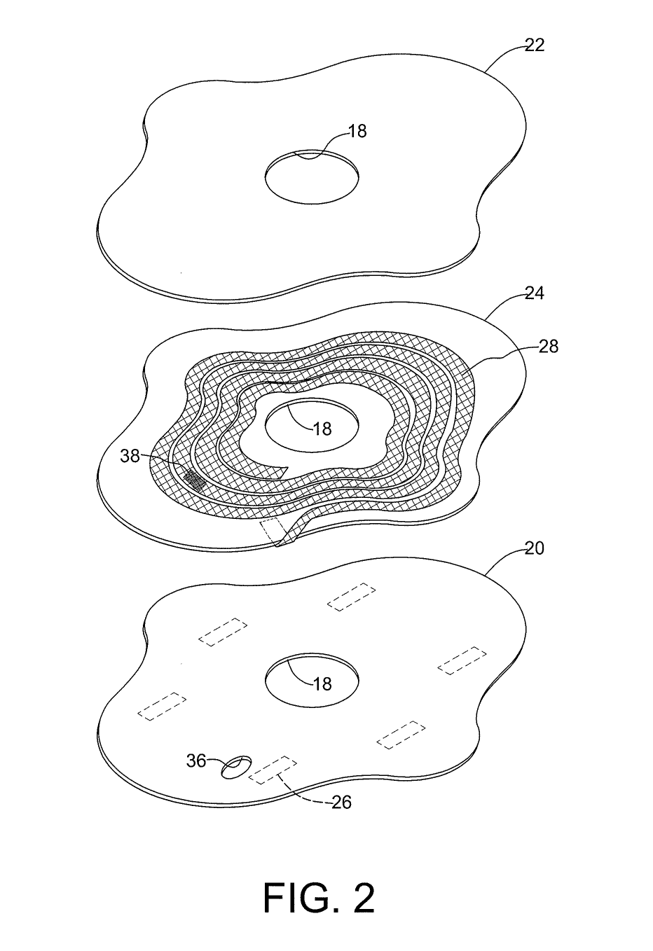

As shown in FIG. 2, heating pad 12 includes an outer fabric layer 20 for removable attachment to a brace, an inner fabric layer 22 for contacting the skin of a user, and a middle fabric layer 24 situated between outer layer 20 and inner layer 22.

Outer layer 20 may be made from polyester felt or other suitable fabric, and may be adapted for releasable attachment to an overlying brace by the provision of a plurality of micro-hook (i.e. VELCRO®) strips 26 sewn on an outwardly facing surface of outer layer 20 for engaging fabric on the brace. Outer layer 20 acts as an insulating layer to inhibit heat loss through the brace and keep most of the heat transfer in the direction of the user. A 100% polyester felt fabric is effective for this purpose, however other fabrics may be used.

Inner layer 22 contacts the user's skin. Therefore, the material for inner layer 22 may be selected to wick moisture away from the skin to prevent build up of perspiration and help keep the skin dry and comfortable. A nylon-LYCRA® blend fabric is suitable for this purpose, however other fabric materials may be substituted.

Pad 12 further includes a conductive heating element 28, described below. Middle layer 24 serves as a substrate for conductive heating element 28. Polyester woven fabric is suitable for making middle layer 24, however other fabrics may be used.

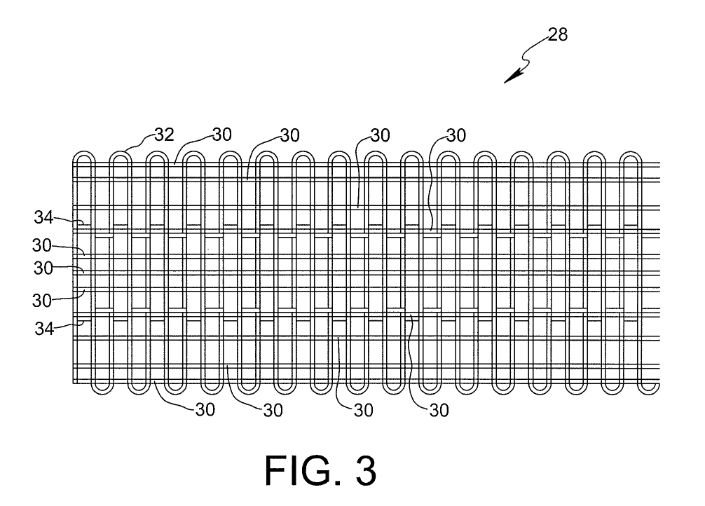

Heating element 28 of the present embodiment is shown in detail in FIG. 3. Heating element 24 may be formed as a flexible tape woven from polyester filament yarn and conductive yarn. In the depicted embodiment, the tape is about twelve millimeters wide and includes eleven nonconductive, generally-parallel warp threads 30 and one nonconductive weft thread 32 interlaced back and forth across all eleven warp threads 30. As mentioned, the nonconductive threads may be made of polyester filament yarn. A suitable linear mass density of the polyester filament yarn is 150 Denier, however yarns of other densities may also be suitable. Heating element 28 also includes at least one conductive thread for generating resistive heat when current is applied. As shown in the embodiment of FIG. 3, two conductive yarn weft threads 34 are interlaced about the fourth and eighth nonconductive warp threads, respectively, to run the length of heating element 28. A suitable conductive yarn for forming conductive threads 34 is BEKINOX® continuous stainless steel filament yarn, Type VN 14/1x90/200Z/316 L/HT, sold by NV Bekaert SA. By forming heating element 28 in this manner, the conductive threads 34 are supported so that they will be less apt to break or splinter, and heating element 28 may be sewn onto middle layer 24 by an attachment thread that engages only nonconductive threads of the heating element. Sewing is a preferred method of fixing heating element 28 to middle layer 24, however other methods may be used, including adhesives, staples, and the like.

In the present embodiment, heating element 28 is arranged in spiral fashion around patella hole 18 on the side of middle layer 24 facing inner layer 22, and a terminal end of the heating element is wrapped around onto the opposite side of middle layer 24. Terminal ends of conductive threads 34 are crimped and connected by electrical cord 16 to control module 14. A lead opening 36 may be provided through outer layer 20 via which electrical cord 16 may be connected to the conductive threads 34 of heating element 28.

Pad 12 also includes a temperature sensor 38 attached, such as by sewing, onto heating element 28 and/or middle layer 24. The DS18S20 High-Precision 1-WIRE® digital thermometer from Dallas Semiconductor/Maxim is suitable as temperature sensor 38. A conformal coating, such as HUMISEAL® or CRC Acryform, is applied to temperature sensor 38 to protect it from moisture. An electrical lead (not shown) to temperature sensor 38 may be bundled in electrical cord 16.

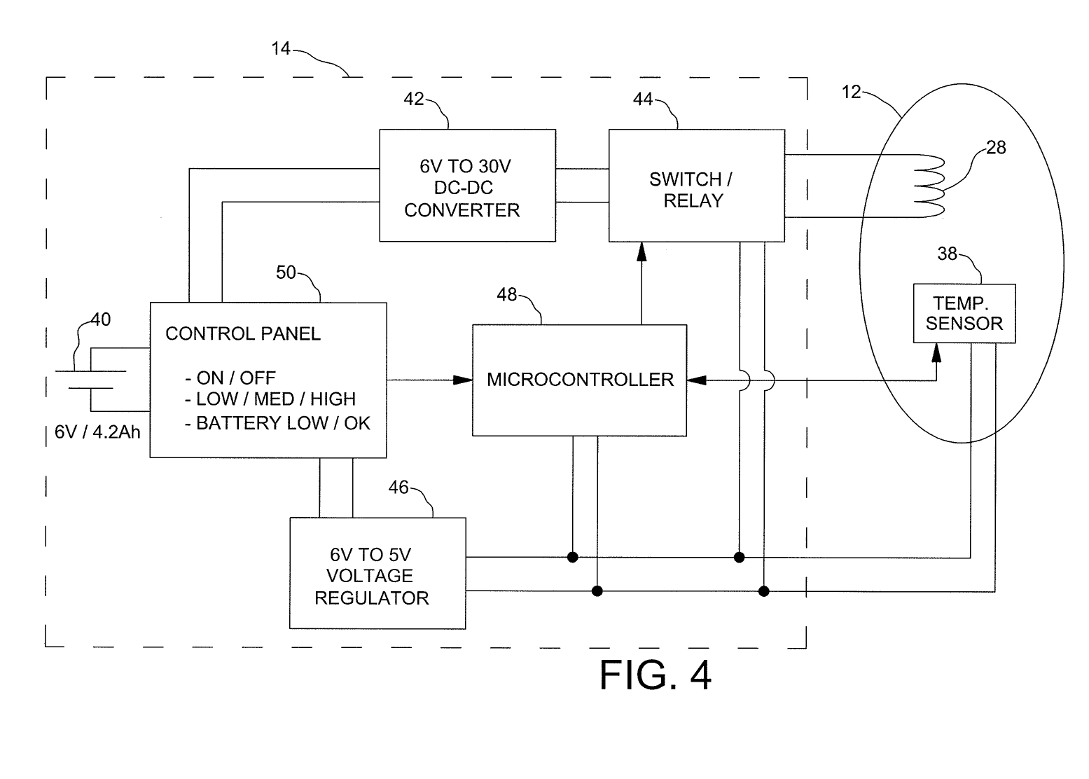

Reference is also made now to FIG. 4, which provides a schematic diagram of the electrical components of heating pad system 10. A DC power source 40 supplies power to control module 14, heating element 28, and temperature sensor 38. For sake of the present embodiment, power source 40 may be a 6 Volt/4.2 Amp-Hour battery pack, for example a POWERIZER® 6V4200 mAh Ni-MH rechargeable battery, available from www.batteryspace.com under number RA-H43AF5R1TB. A 6V to 30V DC-DC converter 42 connected to power source 40 provides sufficient voltage to energize heating element 28 via a switch/relay 44. A 6V to 5V voltage regulator 46 connected to power source 40 provides operating power to a microcontroller 48, switch/relay 44, and temperature sensor 38. A Philips Semiconductor P89C669 eight-bit microcontroller with extended memory may be used as microcontroller 48, however other microcontrollers may be substituted without straying from the invention. A control panel 50 on control module 14 provides an on/off switch and temperature selector, and may also include an LED indicator 51, preferably a red LED, for signaling that power source 40 is low on charge and in need of recharging. Another LED indicator (not shown), such as a green LED, may be provided to indicate that module 14 is powered on. In the embodiment described at present, the temperature selector is a three-position selector providing low, medium, and high temperature settings. Those skilled in the art will realize that fewer or more than three discrete temperature settings may be provided, or a continuously variable temperature selector (for example a dial or slider) may be provided. Microcontroller 48 receives a temperature setting from control panel 50 and a temperature reading from temperature sensor 38, and operates switch/relay 44 as needed to maintain a predetermined temperature corresponding to the selected temperature setting. By way of example, a low temperature setting may correspond to 40° C., a medium temperature setting may correspond to 42° C., and a high temperature setting may correspond to 45° C.

In the present embodiment, heating element 28 should impose a resistance of at least ninety ohms to produce sufficient heat. Also, it is advantageous (but not a strict requirement) that the conductive threads 34 be spaced within five to seven millimeters of one another to provide a uniform heat distribution. Consequently, a heating element length of 2.4 meters may be used with two conductive threads 34 in parallel in the disclosed embodiment.

Heating pad system 10 may be fabricated and assembled in the following manner. Outer layer 20, inner layer 22, and middle layer 24 are cut to size. The coated temperature sensor 38 is sewn onto heating element 28, and the heating element 28 is arranged on middle layer 24 in a spiral pattern about patella hole 18 and sewn to the middle layer (a terminal end of the heating element is left unattached and is wrapped around to the opposite side of the middle layer as shown in FIG. 2). The terminal end of heating element 28 is crimped, and conductive threads 34 and temperature sensor 38 are connected to lead wires extending through electrical cord 16. Inner layer 22 is arranged to cover heating element 28, thereby ensuring that the conductive threads 34 face inward toward the user's skin. The outer layer is placed on the opposite side of middle layer 24 with micro-hook strips 26 facing away from middle layer 24, and the wiring is passed through lead opening 36 in outer layer 20. The layers 20, 22, and 24 are then sewn to one another by embroidery stitches 21 and 23 along the peripheral edges of pad 12 and patella hole 18, respectively. Electrical cord 16 may then be connected to control module 14.

Heating pad system 10 is used by placing heating pad 12 in contact with the body area to be treated, and donning a brace over the pad such that micro-hook strips 26 affix to fabric on the brace, whereby heating pad 12 is held in place. Control panel 50 is used to turn control module 14 on and select a temperature setting. It is contemplated to provide braces designed to hold control module 14, such as by hook-and-loop fastening strips or a fitted pocket, while heating pad system 10 is in use. As mentioned above, pad 12 is machine-washable between uses. Electrical cord 16 is disconnected from control module 14 prior to washing heating pad 12, and may be left connected to the pad during washing or may be disconnected from the pad if a plug connection is provided at the pad.

While the invention has been described in connection with an exemplary embodiment, the detailed description is not intended to limit the scope of the invention to the particular forms set forth. The invention is intended to cover such alternatives, modifications, and equivalents of the described embodiment as may be included within the spirit and scope of the invention.

What is claimed is:

1. A heating pad system comprising:
a pad including a plurality of layers formed of flexible material;
a heating element applied to or embedded within one of the plurality of layers of the pad, the heating element including conductive yarn;
a temperature sensor associated with the pad, the temperature sensor generating a temperature signal indicative of a temperature of the pad; and
a control module removably connected to the heating element and the temperature sensor, the control module being operable to supply current to the heating element to generate heat, wherein the current supplied to the heating element is regulated in response to the temperature signal to maintain the pad at a substantially constant temperature;
wherein the plurality of layers of the pad, the heating element, and the temperature sensor are machine-washable as a unit.

2. The heating pad system according to claim 1, wherein the control module includes a microcontroller for controlling the supply of current to the heating element in response to the temperature signal.

3. The heating pad system according to claim 1, wherein the control module is settable by a user to a chosen one of a plurality of temperature settings, and the current supplied to the heating element is regulated to maintain the pad at a temperature corresponding to the chosen temperature setting.

4. The heating pad system according to claim 3, wherein the plurality of temperature settings are discrete settings.

5. The heating pad system according to claim 4, wherein the plurality of temperature settings includes 40° C., 42° C., and 45° C.

6. The heating pad system according to claim 1, wherein the control module includes a rechargeable battery as a direct current power source, and a light-emitting diode is connected to the power source for indicating a low battery condition.

7. The heating pad system according to claim 1, wherein a waterproof coating is applied to the temperature sensor.

8. The heating pad system according to claim 1, wherein the plurality of layers of the pad includes an inner layer for contacting skin of a user, an outer layer for contacting an orthopedic brace, and a middle layer between the inner and outer layers, the heating element and the temperature sensor being applied to the middle layer, and the inner, outer, and middle layers being sewn together.

9. The heating pad system according to claim 1, wherein the heating element comprises a length of woven tape including the conductive yarn.

10. The heating pad system according to claim 9, wherein the woven tape includes nonconductive yarn, and the conductive yarn is interwoven with the nonconductive yarn.

11. A machine-washable electric heating pad comprising:
an inner layer, an outer layer, and a middle layer between the inner and outer layers; and
a heating element fixed to the middle layer, the heating element including conductive yarn.

12. The heating pad according to claim 11, wherein the heating element is a length of woven tape including nonconductive yarn with which the conductive yarn is interwoven.

13. The heating pad according to claim 12, wherein the length of woven tape is arranged in a spiral pattern about a center of the pad.

14. The heating pad according to claim 11, wherein the inner layer is made of a wicking fabric.

15. The heating pad according to claim 11, wherein the middle layer is made of a woven polyester fabric.

16. The heating pad according to claim 11, wherein the outer layer is made of polyester felt.

17. A heating element for a machine-washable heating pad, the heating element comprising:
a plurality of parallel nonconductive warp threads;
a nonconductive weft thread interlaced with the plurality of warp threads; and
a conductive weft thread interlaced about one of the plurality of nonconductive warp threads.

18. The heating element according to claim 17, wherein the plurality of nonconductive warp threads and the nonconductive weft thread are formed of polyester filament yarn.

19. The heating element according to claim 17, wherein the conductive weft thread is formed of stainless steel filament yarn.

20. The heating element according to claim 17, further comprising another conductive weft thread interlaced about another one of the plurality of nonconductive warp threads.
